(19) United States
(12) Patent Application Publication
(10) Pub. No.: US 2021/0255717 A1
(43) Pub. Date: Aug. 19, 2021

(54) TOUCH PANEL AND METHOD FOR FABRICATING THE SAME

(71) Applicants: SHENZHEN ROYOLE DISPLAY SYSTEM TECHNOLOGY CO.,LTD., Shenzhen (CN); Shenzhen Royole Technologies Co., Ltd., Shenzen (CN)

(72) Inventors: Xiaohua Lei, Shenzhen (CN); Kangjun Hu, Shenzhen (CN); He Li, Shenzhen (CN)

(21) Appl. No.: 17/307,145

(22) Filed: May 4, 2021

Related U.S. Application Data
(63) Continuation of application No. PCT/CN2018/114565, filed on Nov. 8, 2018.

(51) Int. Cl. G06F 3/041

(52) U.S. Cl. CPC G06F 3/041; G06F 2203/04103; G06F 2203/04107

(57) ABSTRACT

The present disclosure provides a touch panel. The touch panel includes a first touch panel body (100). The first touch panel body (100) includes a substrate layer (10), a conductive layer (20), and a shielding layer (30). The conductive layer (20) is disposed on the substrate layer (10), and includes an outer side surface (201). The shielding layer (30) covers the outer side surface (201) of the conductive layer (20) to insulate the conductive layer (20) from an external environment.

### CROSS-REFERENCE TO RELATED APPLICATIONS

This application is a continuation-application of International (PCT) Patent Application No. PCT/CN2018/114565, filed on Nov. 8, 2018, and entitled “touch panel and method for fabricating the same”, the entire contents of which are incorporated herein by reference.

### TECHNICAL FIELD

The present disclosure relates to the field of touch technologies, and in particular, relates to a touch panel and a method for fabricating the touch panel.

### BACKGROUND

Touch panels, due to convenience in man-machine interaction, have been widely applied to smart phones, tablet personal computers, personal digital assistants (PDAs), laptop personal computers, and the like electronic products. However, in the currently manufactured touch panels, peripheral sections of a conductive layer of the touch panel are totally exposed to the outside, and are thus affected by an external environment, for example, reaction with moisture, or with oxygen, or with other penetrated substances. As a result, the conductive layer may, to some extent, progressively fail.

### SUMMARY

A touch panel according to an embodiment of the present disclosure includes a first touch panel body. The first touch panel body includes a substrate layer, a conductive layer, and a shielding layer. The conductive layer is disposed on the substrate layer, and includes an outer side surface. The shielding layer covers the outer side surface of the conductive layer to insulate the conductive layer from an external environment.

A method for fabricating a touch panel according to an embodiment of the present disclosure includes: providing a substrate layer; forming a conductive layer on the substrate layer, wherein the conductive layer comprises an outer side surface; disposing a shielding layer on the outer side surface of the conductive layer, thus covering the outer side surface of the conductive layer and forming a first touch panel body, wherein the shielding layer insulates the conductive layer from an external environment.

### BRIEF DESCRIPTION OF THE DRAWINGS

For clearer description of technical solutions according to embodiments of the present disclosure or in the related art, drawings that are to be referred for description of the embodiments or the related art are briefly described hereinafter. Apparently, the drawings described hereinafter merely illustrate some embodiments of the present disclosure. Persons of ordinary skill in the art may also derive other drawings based on the drawings described herein without any creative effort.

FIG. 1 is a schematic structural diagram of a first touch panel body according to embodiments of the present disclosure.

FIG. 2 is a schematic structural diagram of the first touch panel body in FIG. 1 with a shielding layer removed.

FIG. 3 is a schematic structural diagram of a touch panel according to a first embodiment of the present disclosure.

FIG. 4 is a schematic structural diagram of a touch panel according to a second embodiment of the present disclosure.

FIG. 5 is a schematic structural diagram of a touch panel according to a third embodiment of the present disclosure.

FIG. 6 is a schematic structural diagram of a touch panel according to a fourth embodiment of the present disclosure.

FIG. 7 is a schematic structural diagram of a touch panel according to a fifth embodiment of the present disclosure.

FIG. 8 is a schematic structural diagram of a touch panel according to a sixth embodiment of the present disclosure.

FIG. 9 is a schematic structural diagram of a touch panel according to a seventh embodiment of the present disclosure.

FIG. 10 is a schematic structural diagram of a touch panel according to an eighth embodiment of the present disclosure.

FIG. 11 is a schematic structural diagram of a touch panel according to a ninth embodiment of the present disclosure.

FIG. 12 is a schematic structural diagram of a touch panel according to a tenth embodiment of the present disclosure.

FIG. 13 is a schematic structural diagram of a touch panel according to an eleventh embodiment of the present disclosure.

FIG. 14 is a schematic structural diagram of a touch panel according to a twelfth embodiment of the present disclosure.

FIG. 15 is a schematic flowchart of a method for fabricating the touch panel according embodiments of the present disclosure.

### DETAILED DESCRIPTION

The technical solutions of the embodiments of the present disclosure are clearly and thoroughly described hereinafter with reference to the accompanying drawings illustrating the embodiments of the present disclosure.

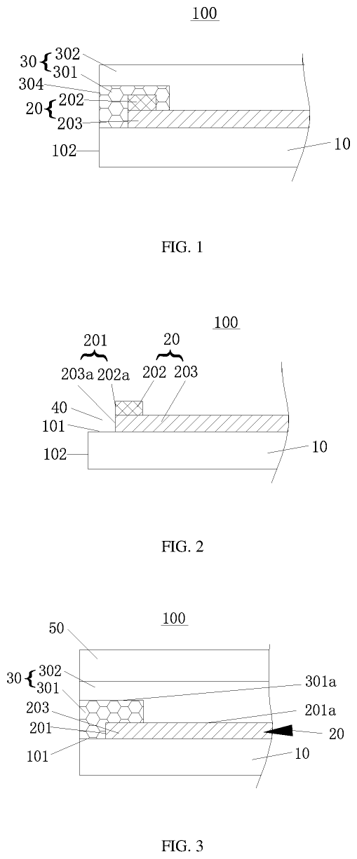

Referring to FIGS. 1 and 2, the present disclosure provides a touch panel. The touch panel includes a first touch panel body 100. The first touch panel body 100 includes a substrate layer 10, a conductive layer 20, and a shielding layer 30. The conductive layer 20 is disposed on the substrate layer 10, and the conductive layer 20 includes an outer side surface 201. The shielding layer 30 covers the outer side surface 201 of the conductive layer 20 to insulate the conductive layer 20 from an external environment.

Therefore, according to the present disclosure, the conductive layer 20 in the touch panel is insulated from the external environment by covering the outer side surface 201 of the conductive layer 20 by the shielding layer 30, and thus peripheral sections of the conductive layer 20 are protected, such that the peripheral sections of the conductive layer 20 are wrapped. This prevents the peripheral sections of the conductive layer 20 from impact caused by the external environment, and hence solves the technical problem that the conductive layer 20 is apt to fail. That is to say, in the present disclosure, conductive substances on the peripheral sections of the conductive layer 20 are prevented from being in direct contact with the external environment, and instead a sealed structure insulated from the external environment is formed. In this way, the conductive layer 20 is not apt to be subject to adverse impact of corrosion, oxidation, penetration, and the like.

In some specific embodiments, the substrate layer 10 includes a surface 101 facing towards the conductive layer 20. The surface 101 and the outer side surface 201 define an accommodation chamber 40. The shielding layer 30 is received in the accommodation chamber 40. That is to say, in the present disclosure, the accommodation chamber 40 is defined by removing or partially removing a conductive substrate layer in an inactive region at the edge of the conductive layer 20, and the peripheral sections of the conductive layer 20 are protected by covering the shielding layer 30 in the accommodation chamber 40, such that the conductive substances of the conductive layer 20 are prevented from being in direct contact with the external environment, and instead a sealed structure insulated from the external environment is formed. In this way, the conductive layer 20 is not apt to be subject to adverse impact of corrosion, oxidation, penetration, and the like. In addition, in the present disclosure, after the conductive substance layer in the inactive region at the edge of the conductive layer 20 is removed or partially removed, the volume of the conductive substance layer in the inactive region of the conductive layer 20 is decreased, such that the accommodation chamber 40 is formed, and hence a space is provided for filling in the shielding layer 30. In this embodiment, the accommodation chamber 40 defined by the outer side surface 201 of the conductive layer 20 and the surface 101 of the substrate layer 10 may be in an L shape. In the present disclosure, the shape of the accommodation chamber 40 is not limited. Whether or not the surface 101 of the substrate layer 10 and the outer side surface 201 of the conductive layer 20 define the accommodation chamber 40 is not limited. However, the surface 101 of the substrate layer 10 may also be flush with the outer side surface 201 of the conductive layer 20.

The substrate layer 10 further includes a side surface 102 connected to the surface 101. When the outer side surface 201 of the conductive layer 20 and the surface 101 of the substrate layer 10 define the accommodation chamber 40, a side surface 304 of the shielding layer 30 formed after the shielding layer 30 is filled in the accommodation chamber 40 and is flush with the side surface 102 of the substrate layer 10. In the present disclosure, whether or not the side surface 304 of the shielding layer 30 is flush with the side surface 102 of the substrate layer 10 is not limited. However, the side surface 304 of the shielding layer 30 and the side surface 102 of the substrate layer 10 may also form steps relative to each other. Referring to FIG. 3, in a first embodiment of the present disclosure, the shielding layer 30 includes a barrier layer 301 and an adhesive layer 302. The barrier layer 301 is connected to the adhesive layer 302. The barrier layer 301 is received in the accommodation chamber 40. The adhesive layer 302 is stacked on the conductive layer 20. The barrier layer 301 and the adhesive layer 302 collaboratively cover the conductive layer 20.

In this embodiment, the conductive layer 20 includes a touch layer 203. The touch layer 203 includes a touch electrode (not illustrated) and a signal trace (not illustrated) electrically connected to the touch electrode. The barrier layer 301 covers the signal trace. That is to say, the barrier layer 301 not only covers the accommodation chamber 40, but also covers the signal trace, which addresses the problem that the signal trace is apt to fail, for example, corrosion or the like.

The barrier layer 301 includes a first upper surface 301a far away from the conductive layer 20, and the adhesive layer 302 is extended towards the barrier layer 301 and covers the first upper surface 301a of the barrier layer 301. Specifically, the barrier layer 301 covers the accommodation chamber 40 and the signal trace, the adhesive layer 302 covers the barrier layer 301 and a remaining surface 201a of the touch layer 203 that is not covered by the barrier layer 301.

The touch panel further includes a protective layer 50. The protective layer 50 is disposed on the shielding layer 30. In this embodiment, the protective layer 50 is adhered to the adhesive layer 302. That is to say, the protective layer 50 is adhered, via the adhesive layer 302, to the barrier layer 301 and the remaining surface 201a of the touch layer 203 on which no signal trace is disposed.

In this embodiment, the barrier layer 301 may be optically transparent or colored in different colors, for example, black, white, or other colors, to achieve the effects of light shielding, hiding conductive lines, decoration, and the like. In this way, the process of printing a decorative ink to the protective layer 50 is not needed, or the requirements of the decorative ink on the protective layer 50 are reduced. The touch electrodes may be subjected to laser or chemical etching on the conductive layer or printed on the substrate layer to form a single-layer electrode pattern or a top-bottom electrode layer pattern. The electrode layer may be made of conductive substances, such as various metals, metals and oxides thereof, nano-metal materials, conductive polymer molecules and the like, on a thin film, glass or the like substrate. The barrier layer 301 may be fabricated by printing, ink-printing, dispensing, spraying, or the like in the accommodation chamber 40 and the signal trace. The adhesive layer 302 may be a pressure-sensitive optical adhesive, a substrate-free double-face adhesive, substrate-based double-face adhesive, or the like.

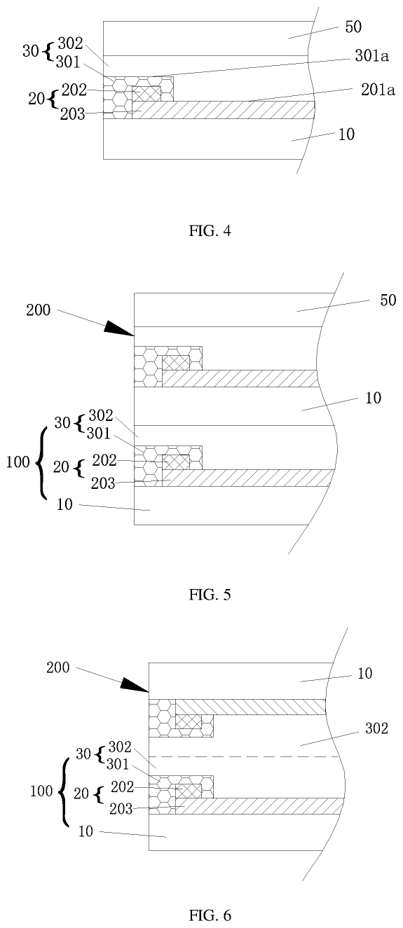

Referring to FIG. 2 and FIG. 4, in a second embodiment of the present disclosure, different from the first embodiment, the conductive layer 20 further includes a conductive trace layer 202. The conductive trace layer 202 is disposed on the touch layer 203. The conductive trace layer 202 includes a conductive trace (not illustrated). The conductive trace covers the signal trace, and is electrically connected to the signal trace. The barrier layer 301 covers the conductive trace. That is to say, in this embodiment, since the signal transmission capability and sensitivity of the touch panel are high, if signal transmission capability of the signal trace is limited, the conductive trace assists in transmitting signals. The conductive trace of the touch panel covers the signal trace, thus the signal trace is not exposed. Therefore, the signal trace is not affected by the external environment, and the signal trace may not fail. In addition, in the present disclosure, since the barrier layer 301 covers on the conductive trace, the conductive trace may not fail either. In this embodiment, the touch layer 203 includes a first sub side surface 203a, and the conductive trace layer 202 includes a second sub side surface 202a. The first sub side surface 203a and the second sub side surface 202a are connected to form the outer side surface 201. The first sub side surface 203a may be flush with the second sub side surface 202a. It may be understood that the first sub side surface 203a may not be flush with the second sub side surface 202a.

The conductive trace layer 202 may be fabricated by printing or curing a conductive ink on the touch layer 203; or may be fabricated by chemically disposing a conductive metal line or the like.

Referring to FIG. 5, in a third embodiment of the present disclosure, the touch panel further includes a second touch panel body 200, the second touch panel body 200 is the same as the first touch panel body 100. The first touch panel body 100 and the second touch panel body 200 are stacked.

In this embodiment, a substrate layer 10 of the second touch panel body 200 is connected to the shielding layer 30 of the first touch panel body 100. The adhesive layer 302 of the first touch panel body 100 is adhered to the substrate layer 10 of the second touch panel body 200, and the protective layer 50 of the first touch panel body 100 is adhered to an adhesive layer 302 of the second touch panel body 200. The first touch panel body 100 in this embodiment is specifically the touch panel body in the second embodiment, and the first touch panel body 100 may also be the touch panel body in the first embodiment, which is not illustrated in the drawings of the present disclosure.

It may be understood that a plurality of second touch panel bodies 200 may be configured. The plurality of second touch panel bodies 200 are first stacked and then stacked on the last first touch panel body 100. The present disclosure sets no limitation to the number of second touch panel bodies 200.

Referring to FIG. 6, in a fourth embodiment of the present disclosure, different from the third embodiment, conductive trace layers 202 are disposed to be opposite to each other, and a shielding layer 30 of a second touch panel body 200 is connected to the shielding layer 30 of the first touch panel body 100. That is to say, an adhesive layer 302 of the second touch panel body 200 is connected to the adhesive layer 302 of the first touch panel body 100. According to the present disclosure, the adhesive layers 302 of the two touch panel bodies are adhered to each other, such that upper and lower surfaces of the touch panel are respectively the substrate layer 10 of the second touch panel body 200 and the substrate layer 10 of the first touch panel body 100. In this way, traces and electronic elements inside the touch panel are protected, and the protective layer 50 does not need to be prepared, thereby reducing cost. In addition, when the touch panel employs multi-layer design, the thickness of the touch panel is reduced because of omitting the protection layer 50.

Referring to FIG. 7, in a fifth embodiment of the present disclosure, different from the first embodiment, the barrier layer 301 includes a first upper surface 301a away from the conductive layer 20, the adhesive layer 302 includes a second upper surface 302a away from the conductive layer 20. The first upper surface 301a is coplanar with the second upper surface 302a. In this embodiment, the barrier layer 301 covers the accommodation chamber 40 and the signal trace, the adhesive layer 302 covers a remaining surface 201a of the touch layer 203 that is not covered by the barrier layer 301. The first upper surface 301a is disposed to be coplanar with the second upper surface 302a to form a flat upper surface 303. The protective layer 50 is stacked and adhered to the flat upper surface 303.

In this embodiment, the barrier layer 301 is different from that in the first embodiment, in this embodiment the barrier layer 301 may also be adhered to the protective layer 50, the outer side surface 201 of the accommodation chamber 40 and the surface 101, and a top surface of the touch layer 203. That is, the barrier layer 301 may be made of a liquid curable or solid thermally meltable material. By heating, irradiation or the like, the barrier layer 301 produces adhesion and adheres the protective layer 50, the outer side surface 201 of the accommodation chamber 40 and the surface 101, and a portion of the top surface of the touch layer 203. Further, since the barrier layer 301 is disposed on an outer side of the adhesive layer 302, when the first upper surface 301a of the barrier layer 301 is coplanar with the second upper surface 302a of the adhesive layer 302, the barrier layer 301 totally covers the side surface of the adhesive layer 302 to insulate the adhesive layer 302 from the external environment. This prevents the adhesive layer 302 from absorbing or attracting dusts, foreign substances or the like impurities, and thus improving appearance and touch feel of the touch panel.

It may be understood that the first upper surface 301a and the second upper surface 302a may not be coplanar with each other, but form a step surface. The protective layer 50 includes a protrusive portion and a recessed portion mating with the step surface. The protrusive portion and the recessed portion of the protective layer 50 may totally mate with the step surface defined by the first upper surface 301a and the second upper surface 302a, with no slit therebetween.

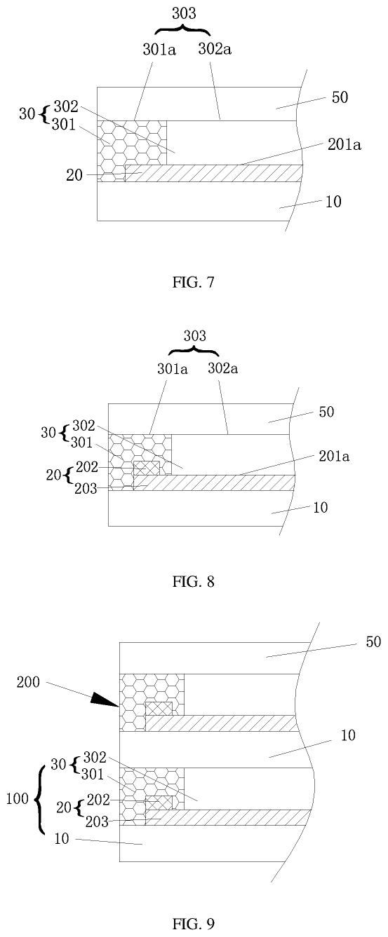

Referring to FIG. 8, which shows a sixth embodiment of the present disclosure. Which is different from the fifth embodiment is that the conductive layer 20 further includes a conductive trace layer 202. The conductive trace layer 202 is disposed on the touch layer 203. The conductive trace layer 202 includes a conductive trace (not illustrated). The conductive trace covers on the signal trace, and is electrically connected to the signal trace. The barrier layer 301 covers the conductive trace. That is to say, in this embodiment, since the signal transmission capability and sensitivity of the touch panel are high, if signal transmission capability of the signal trace is limited, the conductive trace assists in transmitting signals. The conductive trace covers the signal trace, and the signal trace is not exposed. Therefore, the signal trace is not affected by the external environment, and the signal trace may not fail. In addition, in the present disclosure, since the barrier layer 301 covers on the conductive trace, the conductive trace may not fail either.

Referring to FIG. 9, which shows a seventh embodiment of the present disclosure. Which is different from the third embodiment is that the substrate layer 10 of the second touch panel body 200 is connected to the barrier layer 301 and the adhesive layer 302 of the first touch panel body 100. Similarly, a plurality of second touch panel bodies 200 may be configured. The plurality of second touch panel bodies 200 are first stacked and then stacked on the first touch panel body 100. The present disclosure sets no limitation to the number of second touch panel bodies 200.

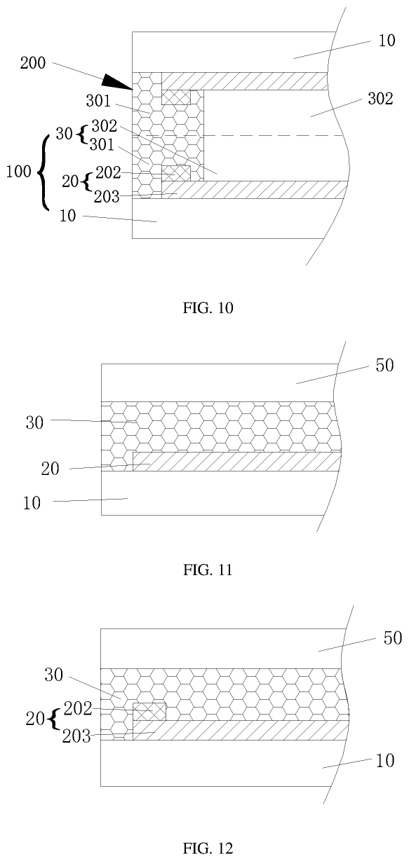

Referring to FIG. 10, which shows an eighth embodiment of the present disclosure. Which is different from the seventh embodiment is that the barrier layer 301 of the second touch panel body 200 is connected to the barrier layer 301 of the first touch panel body 100, and the adhesive layer 302 of the second touch panel body 200 is connected to the adhesive layer 302 of the first touch panel body 100. In this embodiment, the protective layer 50 is omitted to be fabricated, thereby reducing cost. In addition, when the touch panel employs multi-layer design, the thickness of the touch panel is reduced because the protection layer 50 is omitted.

Referring to FIG. 11, which shows a ninth embodiment of the present disclosure. Which is different from the first embodiment and the fifth embodiment is that the shielding layer 30 is the barrier layer 301, and the barrier layer 301 totally covers the conductive layer 20. That is, the barrier layer 301 totally covers the accommodation chamber 40 and the touch layer 203. The barrier layer 301 and the adhesive layer 302 are made of the same material. The barrier layer 301 may be a liquid curable or solid thermally meltable material. By heating, irradiation or the like, the barrier layer 301 produces adhesion and adheres the substances in the upper and lower layers.

Referring to FIG. 12, which shows a tenth embodiment of the present disclosure. Which is different from the ninth embodiment is that the conductive layer 20 further includes a conductive trace layer 202. The conductive trace layer 202 is disposed on the touch layer 203. The conductive trace layer 202 includes a conductive trace (not illustrated). The conductive trace covers on the signal trace, and is electrically connected to the signal trace. The barrier layer 301 covers the conductive trace. That is to say, in this embodiment, since the signal transmission capability and sensitivity of the touch panel are high, if signal transmission capability of the signal trace is limited, the conductive trace assists in transmitting signals. The conductive trace covers the signal trace, and the signal trace is not exposed. Therefore, the signal trace is not affected by the external environment, and the signal trace may not fail. In addition, in the present disclosure, since the barrier layer 301 covers the conductive trace, the conductive trace may not fail either.

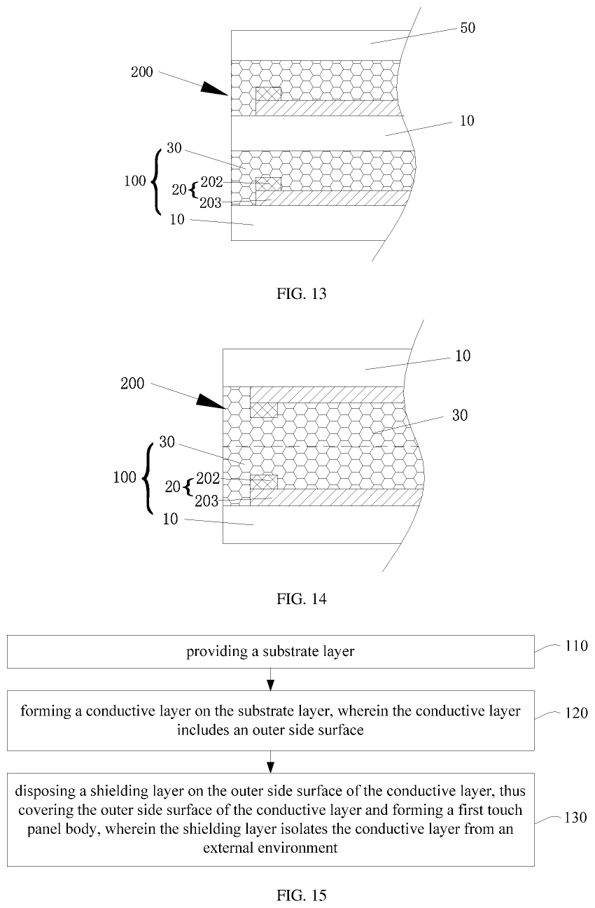

Referring to FIG. 13, which shows an eleventh embodiment of the present disclosure. Which is different from the ninth embodiment is that the substrate layer 10 of the second touch panel body 200 is connected to the barrier layer 301 of the first touch panel body 100. Similarly, a plurality of second touch panel bodies 200 may be configured. The plurality of second touch panel bodies 200 are first stacked and then stacked on the first touch panel body 100. The present disclosure sets no limitation to the number of second touch panel bodies 200.

Referring to FIG. 14, which shows a twelfth embodiment of the present disclosure. Which is different from the eleventh embodiment is that the barrier layer 301 of the second touch panel body 200 is connected to the barrier layer 301 of the first touch panel body 100. In this embodiment, the protective layer 50 is omitted to be fabricated, thereby reducing cost. In addition, when the touch panel employs multi-layer design, the thickness of the touch panel is reduced because no protection layer 50 is disposed.

Referring to FIG. 15, the present disclosure provides a method for fabricating a touch panel. The method includes the following steps.

Step 110: providing a substrate layer 10.

Step 120: forming a conductive layer 20 on the substrate layer 10, wherein the conductive layer 20 includes an outer side surface 201.

Step 130: disposing a shielding layer 30 on the outer side surface 201 of the conductive layer 20, thus covering the outer side surface 201 of the conductive layer 20 and forming a first touch panel body 100, wherein the shielding layer 30 insulates the conductive layer 20 from an external environment.

Therefore, in the method for fabricating the touch panel according to the present disclosure, the shielding layer 30 covering the outer side surface 201 of the conductive layer 20 is disposed on the outer side surface 201 of the conductive layer 20, and thus peripheral sections of the conductive layer 20 are protected, such that the peripheral sections of the conductive layer 20 are wrapped. This prevents the peripheral sections of the conductive layer 20 from impact caused by the external environment, and hence solves the technical problem that the conductive layer 20 is apt to fail. More specifically, in the present disclosure, conductive substances on the peripheral sections of the conductive layer 20 are prevented from being in direct contact with the external environment, and instead a sealed structure insulated from the external environment is formed. Therefore, the conductive layer 20 is not apt to be subject to adverse impact of corrosion, oxidation, penetration, and the like.

In the present disclosure, the shielding layer 30 may be a barrier layer 301, wherein the barrier layer 301 totally covers the conductive layer 20. The shielding layer 30 may further include a barrier layer 301 and an adhesive layer 302. The barrier layer 301 and the adhesive layer 302 collaboratively cover the conductive layer 20. The barrier layer 301 and the adhesive layer 302 set no limitation to the coverage area on the conductive layer 20, as long as the barrier layer 301 and the adhesive layer 302 collaboratively totally cover the conductive layer 20.

Step 120 further includes step 121, patterning the conductive layer 20 on the substrate layer 10 to form a touch layer 203.

Step 130 further includes: filling the shielding layer 30 into an accommodation chamber 40 defined by a surface 101 of the substrate layer 10 and the outer side surface 201 of the conductive layer 20. In this embodiment, when the shielding layer 30 is the barrier layer 301, the barrier layer 301 totally covers the touch layer 203. When the shielding layer 30 further includes an adhesive layer 302, the barrier layer 301 and the adhesive layer 302 collaboratively cover the touch layer 203. Neither of the barrier layer 301 and the adhesive layer 302 sets a limitation to the coverage area on the touch layer 203, as long as the barrier layer 301 and the adhesive layer 302 collaboratively totally cover the touch layer 203.

In some embodiments, step 120 further includes step 122, forming a conductive trace layer 202 on the touch layer 203.

In this embodiment, when the shielding layer 30 is the barrier layer 301, the barrier layer 301 totally covers the conductive trace layer 202 and the touch layer 203 where no conductive trace layer 202 is disposed. When the shielding layer 30 further includes the adhesive layer 302, the barrier layer 301 totally covers the conductive trace layer 202 thus no conductive trace layer 202 is disposed, and the touch layer 203 is covered by the barrier layer 302 and the adhesive layer 302 collaboratively. Neither of the barrier layer 301 and the adhesive layer 302 sets a limitation to the coverage area on the touch layer 203, as long as the adhesive layer 301 and the adhesive layer 302 collaboratively totally cover the touch layer 203.

That is to say, in the present disclosure, the accommodation chamber 40 is defined by removing or partially removing a conductive substrate layer in an inactive region at the edge of the conductive layer 20, and the peripheral sections of the conductive layer 20 are protected by covering the shielding layer 30 in the accommodation chamber 40, such that the conductive substances of the conductive layer 20 are prevented from being in directly contacted with the external environment, and a sealed structure insulated from the external environment is formed. In this way, the conductive layer 20 is not apt to be subject to adverse impact of corrosion, oxidation, penetration, and the like. In addition, in the present disclosure, after the conductive substance layer in the inactive region at the edge of the conductive layer 20 is removed or partially removed, the volume of the conductive substance layer in the inactive region of the conductive layer 20 is decreased, such that the accommodation chamber 40 is formed, and hence a space is provided for filling in the shielding layer 30.

The method further includes step 140, stacking a second touch panel body 200 the same as the first touch panel body 100 on the first touch panel body 100. In this embodiment, a substrate layer 10 of the second touch panel body 200 is connected to the shielding layer 30 of the first touch panel body 100. For example, the adhesive layer 302 of the first touch panel body 100 is adhered to the substrate layer 10 of the second touch panel body 200; or the substrate layer 10 of the second touch panel body 200 is connected to the barrier layer 301 and the adhesive layer 302 of the first touch panel body 100; or the substrate layer 10 of the second touch panel body 200 is connected to the barrier layer 301 of the first touch panel body 100.

It may be understood that a plurality of second touch panel bodies 200 may be configured. The plurality of second touch panel bodies 200 are first stacked and then stacked on the first touch panel body 100. The present disclosure sets no limitation to the number of second touch panel bodies 200.

The method further includes step 150, forming a protective layer 50 on the shielding layer 30 of the first touch panel body 100 or a shielding layer 30 of the second touch panel body 200.

In other embodiments, the shielding layer 30 of the second touch panel body 200 is connected to the shielding layer 30 of the first touch panel body 100, and an adhesive layer 302 of the second touch panel body 200 is connected to the adhesive layer 302 of the first touch panel body 100; or a barrier layer 301 of the second touch panel body 200 is connected to the barrier layer 301 of the first touch panel body 100, and an adhesive layer 302 of the second touch panel body 200 is connected to the adhesive layer 302 of the first touch panel body 100; or a barrier layer 301 of the second touch panel body 200 is connected to the barrier layer 301 of the first touch panel body 100.

In some preferred embodiments, the shielding layers 30 of the two touch panel bodies are connected to each other, such that upper and lower surfaces of the touch panel are respectively the substrate layer 10 of the second touch panel body 200 of the second touch panel and the substrate layer 10 of the first touch panel body 100 of the first touch panel. In this way, traces and devices inside the touch panel are protected, and the protective layer 50 does not need to be prepared, thereby reducing cost. In addition, when the touch panel employs multi-layer design, the thickness of the touch panel is reduced because no protection layer 50 is disposed.

Described above are only exemplary embodiments of the present disclosure, and are not intended to limit the scope of the present disclosure. Persons of ordinary skill in the art would appreciate that all or a part of processes implementing the above embodiments, and other equivalent variations made based on the claims of the present disclosure shall all fall within the scope of the present disclosure.

1. A touch panel, comprising a first touch panel body, wherein the first touch panel body comprises a substrate layer, a conductive layer, and a shielding layer, the conductive layer is disposed on the substrate layer, and comprises an outer side surface; the shielding layer covers the outer side surface of the conductive layer to insulate the conductive layer from an external environment.

2. The touch panel according to claim 1, wherein the substrate layer comprises a surface facing towards the conductive layer, the surface and the outer side surface defines an accommodation chamber, the shielding layer is filled in the accommodation chamber.

3. The touch panel according to claim 2, wherein the shielding layer comprises a barrier layer, the barrier layer is received in the accommodation chamber.

4. The touch panel according to claim 3, wherein the conductive layer comprises a touch layer, the touch layer comprises a touch electrode and a signal trace electrically connected to the touch electrode, the barrier layer covers the signal trace.

5. The touch panel according to claim 4, wherein the conductive layer further comprises a conductive trace layer, the conductive trace layer is disposed on the touch layer, the conductive trace layer comprises a conductive trace, the conductive trace covers the signal trace and is electrically connected to the signal trace, the barrier layer covers the conductive trace.

6. The touch panel according to claim 4, wherein the barrier layer totally covers the conductive layer.

7. The touch panel according to claim 3, wherein the shielding layer further comprises an adhesive layer, the adhesive layer is stacked on the conductive layer, the barrier layer is connected to the adhesive layer, the barrier layer and the adhesive layer cooperatively covers the conductive layer.

8. The touch panel according to claim 7, wherein the barrier layer comprises a first upper surface far away from the conductive layer, and the adhesive layer comprises a second upper surface far away from the conductive layer, the first upper surface is coplanar with the second upper surface.

9. The touch panel according to claim 7, wherein the barrier layer comprises a first upper surface far away from the conductive layer, and the adhesive layer is extended towards the barrier layer and covers the first upper surface of the barrier layer.

10. The touch panel according to claim 1, further comprising a second touch panel body being the same as the first touch panel body, wherein the first touch panel body and the second touch panel body are stacked.

11. The touch panel according to claim 10, wherein a substrate layer of the second touch panel body is connected to the shielding layer of the first touch panel body.

12. The touch panel according to claim 10, wherein a shielding layer of the second touch panel body is connected to the shielding layer of the first touch panel body.

13. The touch panel according to claim 1, further comprising a protective layer, wherein the protective layer is disposed on the shielding layer of the first touch panel body.

14. The touch panel according to claim 11, further comprising a protective layer, wherein the protective layer is disposed on the shielding layer of the second touch panel body.

15. A method for fabricating a touch panel, comprising:
providing a substrate layer;
forming a conductive layer on the substrate layer, wherein the conductive layer comprises an outer side surface; and
disposing a shielding layer on the outer side surface of the conductive layer, thus covering the outer side surface of the conductive layer and forming a first touch panel body, wherein the shielding layer insulates the conductive layer from an external environment.

16. The method according to claim 15, wherein the disposing a shielding layer on the outer side surface of the conductive layer, thus covering the outer side surface of the conductive layer and forming a first touch panel body comprises:
filling the shielding layer into an accommodation chamber defined by a surface of the substrate layer and the outer side surface of the conductive layer.

17. The method according to claim 15, wherein the forming a conductive layer on the substrate layer comprises:
patterning the conductive layer on the substrate layer to form a touch layer.

18. The method according to claim 17, wherein the forming a conductive layer on the substrate layer further comprises:
forming a conductive trace layer on the touch layer.

19. The method according to claim 18, further comprising:
stacking a second touch panel body the same as the first touch panel body on the first touch panel body.

20. The method according to claim 15, further comprising:
forming a protective layer on the shielding layer of the first touch panel body.
